(19) United States
(12) Patent Application Publication
(10) Pub. No.: US 2015/0035790 A1
(43) Pub. Date: Feb. 5, 2015

(54) SELF-CAPACITIVE TOUCH PANEL AND TOUCH DISPLAY DEVICE

(71) Applicant: FocalTech Systems, Ltd., Grand Cayman (KY)

(72) Inventors: Lianghua Mo, Shenzhen (CN); Weiping Liu, Shenzhen (CN)

(73) Assignee: FocalTech Systems, Ltd., Grand Cayman (KY)

(21) Appl. No.: 14/080,068

(22) Filed: Nov. 14, 2013

(30) Foreign Application Priority Data
Aug. 2, 2013 (CN) 201310334838.X

(51) Int. Cl. G06F 3/044

(52) U.S. Cl. CPC G06F 3/044
USPC 345/174

(57) ABSTRACT

A self-capacitive touch panel is provided, including: a plurality of self-capacitive touch sensing electrodes arranged on a single layer; a touch control circuit configured to drive the plurality of self-capacitive touch sensing electrodes, to detect the changes of the self-capacitances of the plurality of self-capacitive touch sensing electrodes, and to determine a touch position based on the changes of the self-capacitances; an insulating layer covering the surface of the plurality of self-capacitive touch sensing electrodes; and an isolating electrode covering the surface of the insulating layer and connected to the touch control circuit. With the solutions according to the embodiments of the invention, the accuracy of touch detection may be enhanced.

### CROSS REFERENCE TO RELATED APPLICATION

The present application claims the priority to Chinese Patent Application No. 201310334838.X, entitled as “SELF-CAPACITIVE TOUCH PANEL AND TOUCH DISPLAY DEVICE”, filed on Aug. 2, 2013 with State Intellectual Property Office of PRC, which is incorporated herein by reference in its entirety.

### BACKGROUND

1. Field of the Disclosure

The disclosure relates to the touch control technology, and in particular, to a self-capacitive touch panel and a touch display device comprising the self-capacitive touch panel.

2. Background of the Technology

The self-capacitive touch panel is now widely used in electronic products such as smart phones, tablet computers, etc. However, the coordinates of a touch position may be reported with an offset or wrongly in the case that an existing single-layer self-capacitive touch panel is pressed heavily. Furthermore, touch detection may be interfered when a liquid crystal display module works. These problems may affect the accuracy of touch detection.

### SUMMARY

Accordingly, a self-capacitive touch panel and a touch display device comprising the self-capacitive touch panel are provided according to embodiments of the disclosure, and are adapted to enhance the accuracy of touch detection.

The self-capacitive touch panel according to the embodiments of the disclosure includes:

a plurality of self-capacitive touch sensing electrodes arranged on a single layer;

a touch control circuit configured to drive the plurality of self-capacitive touch sensing electrodes, to detect the changes of the self-capacitances of the plurality of self-capacitive touch sensing electrodes, and to determine a touch position based on the changes of the self-capacitances;

an insulating layer covering the surface of each of the plurality of self-capacitive touch sensing electrodes; and

an isolating electrode covering the surface of the insulating layer and connected to the touch control circuit.

Preferably, the touch control circuit is configured to drive the isolating electrode with a fixed electrical level; or the touch control circuit is configured to drive the isolating electrode with a driving signal for driving the plurality of self-capacitive touch sensing electrodes.

The self-capacitive touch sensing electrodes may be in the shape of triangle.

The isolating electrode may be made of Indium Tin Oxide (ITO) or Graphene.

The touch display device according to the embodiments of the disclosure includes:

the self-capacitive touch panel described above; and

a liquid crystal display module.

In the solution according to the embodiments of the disclosure, the insulating layer and the isolating electrode are disposed on the surface of the single layer of self-capacitive touch sensing electrodes, where the insulating layer covers the surface of the layer of the touch sensing electrodes and the isolating electrode covers the surface of the insulating layer. By driving the isolating electrode, the change of self capacitances of the touch sensing electrodes in the case that the self-capacitive touch panel is pressed heavily may be avoided and hence the error caused by the heavy pressure is avoided; and interference caused when the liquid crystal display module works is shielded, the accuracy of touch detection is enhanced consequently.

### BRIEF DESCRIPTION OF THE DRAWINGS

Drawings used in the description of embodiments are explained briefly as follows for better understanding of the technical solution according to the embodiments of the invention. Apparently, the drawings described in the following are just some of the embodiments of the invention. Other drawings can be obtained by those skilled in the art based on the drawings without inventive efforts.

FIG. 1 illustrates a schematic sectional diagram of an existing self-capacitive touch panel.

FIG. 2 illustrates a schematic sectional diagram of an existing self-capacitive touch panel with deformation caused by a heavy pressure.

FIG. 3 illustrates a schematic sectional diagram of a self-capacitive touch panel according to embodiment 1, embodiment 2 and embodiment 3 of the disclosure.

FIG. 4 illustrates a schematic sectional diagram of a self-capacitive touch panel according to embodiment 1, embodiment 2 and embodiment 3 of the disclosure with deformation caused by a heavy pressure.

FIG. 5 illustrates the shape of self-capacitive touch sensing electrodes in a self-capacitive touch panel according to embodiment 4 of the disclosure.

### DETAILED DESCRIPTION OF THE EMBODIMENTS

For better understanding of the technical solution in the disclosure by those skilled in the art, the technical solution in the embodiments of the disclosure is described hereinafter in conjunction with drawings. Apparently, the embodiments described are merely some embodiments of the application, rather than all embodiments. Any other embodiments obtained based on the embodiments in the application by those skilled in the art without inventive efforts should fall within the scope of protection of the application. For convenience of illustration, sectional views showing the structure of a device are enlarged partially and are not drawn to scale. The drawings are exemplary and are not intended to limit the protection scope of the disclosure. Furthermore, in actual manufacture process, three-dimension sizes, i.e. length, width and depth should be considered.

It is found by inventors of the invention that the coordinates of a touch position may be reported with an offset or wrongly in the case that an existing single-layer self-capacitive touch panel is pressed heavily, and the accuracy of touch detection is affected.

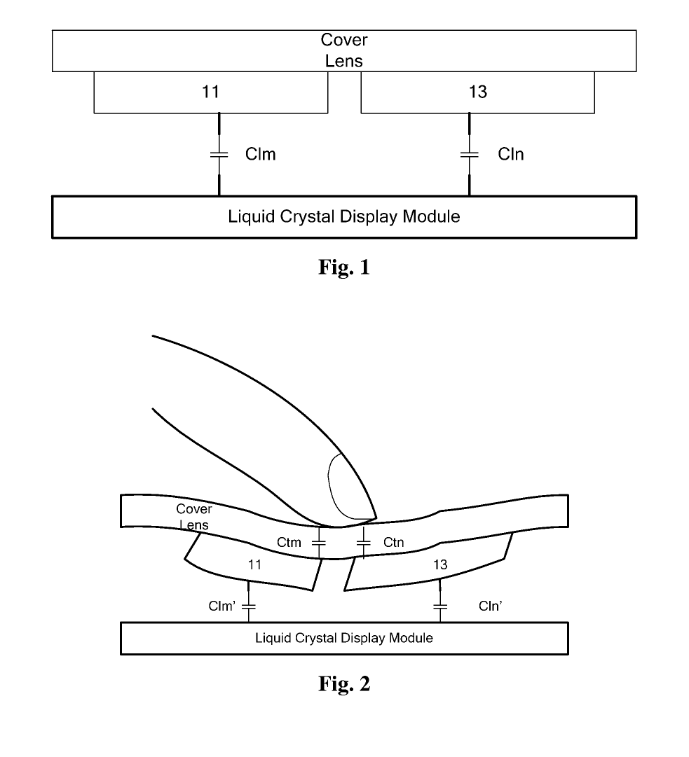

FIG. 1 illustrates a schematic sectional diagram of an existing self-capacitive touch panel. The self-capacitive touch panel includes a cover lens and touch sensing electrodes 11 and 13 disposed below the cover lens. A liquid crystal display module is disposed below the touch sensing electrodes with a gap being provided between the touch sensing electrodes and the liquid crystal display module, and coupling capacitances Clm and Cln are generated in the gap. The coupling capacitances Clm and Cln contribute to the self-capacitances of the touch sensing electrodes respectively.

FIG. 2 illustrates a schematic sectional diagram of an existing self-capacitive touch panel with deformation caused by a heavy pressure. When a touch event takes place on the self-capacitive touch panel shown in FIG. 1 and the pressure is heavy, the panel may be deformed. As shown in FIG. 2, as the distance from the touch sensing electrodes to the liquid crystal display module change, the coupling capacitances Clm and Cln turn into Clm′ and Cln′, respectively. Here the changes of the self capacitances detected in touch detection include not only the capacitances Ctm and Ctn caused by the touch event but also the changes of the coupling capacitances (Clm′-Clm) and (Cln′-Cln), and the calculated coordinates of a touch position may deviate from the actual touch position because of the changes of the coupling capacitances.

In another aspect, in the condition that the touch panel is not touched by human body but is only pressed by an insulating hard object, a false touch event may be reported by a touch detection circuit because of the changes of the coupling capacitances: (Clm′-Clm) and (Cln′-Cln).

In addition, due to the presence of the coupling capacitances, touch detection may be interfered when the liquid crystal display module works, and the accuracy of touch detection is decreased.

### Embodiment 1

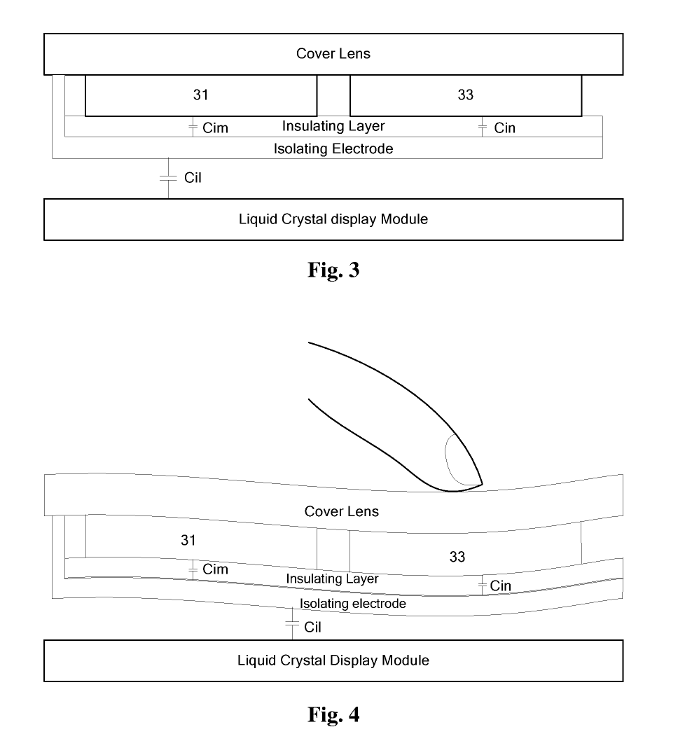

FIG. 3 illustrates a schematic sectional diagram of a self-capacitive touch panel according to embodiment 1 of the disclosure. As shown in FIG. 3, the self-capacitive touch panel according to embodiment 1 of the disclosure includes:

a plurality of self-capacitive touch sensing electrodes arranged on a single layer;

a touch control circuit configured to drive the plurality of self-capacitive touch sensing electrodes, to detect the changes of the self-capacitances of the plurality of self-capacitive touch sensing electrodes, and to determine a touch position based on the changes of the self-capacitances;

an insulating layer covering the surface of each of the plurality of self-capacitive touch sensing electrodes; and

an isolating electrode covering the surface of the insulating layer and connected to the touch control circuit.

As an example shown in FIG. 3, the plurality of self-capacitive touch sensing electrodes include sensing electrodes 31 and 33, coupling capacitance Cim is generated between the sensing electrode 31 and the isolating electrode and coupling capacitance Cin is generated between the sensing electrode 33 and the isolating electrode, and a coupling capacitance Cil is generated between the isolating electrode and the liquid crystal display module.

With the solution according to the embodiments of the disclosure, the change of self capacitances of the touch sensing electrodes in the case that the self-capacitive touch panel is pressed heavily may be avoided and hence the error caused by the heavy pressure is avoided; and interference caused when the liquid crystal display module works is shielded, the accuracy of touch detection is enhanced consequently.

### Embodiment 2

In a self-capacitive touch panel according to embodiment 2 of the disclosure, the touch control circuit is configured to drive the isolating electrode with a fixed electrical level.

Referring FIG. 3, in touch detection, the touch sensing electrodes 31 and 33 charge and discharge the isolating electrode through Cim and Cin, respectively, and Cim and Cin contribute to the self capacitances of the touch sensing electrodes 31 and 33, respectively.

FIG. 4 illustrates a schematic sectional diagram of a self-capacitive touch panel according to embodiment 2 of the disclosure with deformation caused by a heavy pressure. As shown in FIG. 4, the cover lens is deformed when the touch panel is pressed heavily, and since the cover lens, the touch sensing electrodes 31 and 33, the insulating layer and the isolating electrode are arranged closely, the touch sensing electrodes 31 and 33, the insulating layer and the isolating electrode may all be deformed correspondingly. Furthermore, there is a gap above the liquid crystal display module, and the distance between the liquid crystal display module and the isolating electrode turns smaller. Therefore, Cim and Cin change merely and Cil increases.

Because Cim and Cin contribute to the self capacitances of the touch sensing electrodes 31 and 33 while Cil does not, the change of Cil caused by a heavy pressure is not included in the result of touch detection. The self capacitances would not change in the case that the touch panel is not touched by human body but is only pressed by an insulating hard object.

Description about other components according to the embodiment may be referred to other embodiments and is not repeated here.

### Embodiment 3

In a self-capacitive touch panel according to embodiment 3 of the disclosure, the touch control circuit is configured to drive the isolating electrode with a driving signal for driving the plurality of self-capacitive touch sensing electrodes.

Specifically, the touch control circuit may be configured to drive the isolating electrode with a signal having the same waveform as the driving signal for the touch sensing electrode(s) being detected, such that the waveform on the isolating electrode is the same as that on the touch sensing electrode(s) being detected. As a consequence, the isolating electrode and the touch sensing electrode(s) being detected change synchronously and the touch sensing electrode(s) being detected may not charge and discharge the isolating electrode. That is to say, Cim and Cin do not contribute to the self capacitances of the touch sensing electrodes 31 and 33, respectively. Apparently, Cil does not contribute to the self capacitances of the touch sensing electrodes 31 and 33, either. Therefore, the coupling capacitances generated below the touch sensing electrodes may not affect the detection result of the self capacitances in the case that the touch panel is pressed heavily.

Description about other components according to the embodiment may be referred to other embodiments and is not repeated here.

### Embodiment 4

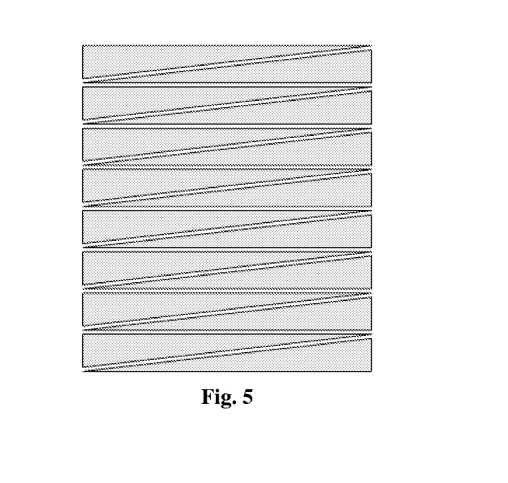

FIG. 5 illustrates the shape of self-capacitive touch sensing electrodes in a self-capacitive touch panel according to embodiment 4 of the disclosure. As shown in FIG. 5, the self-capacitive touch sensing electrodes may be in the shape of triangle.

In addition, the isolating electrode may be made of Indium Tin Oxide (ITO) or Graphene.

Description about other components according to the embodiment may be referred to other embodiments and is not repeated here.

A touch display device is further provided according to the embodiments of the disclosure, where the touch display device includes:

the self-capacitive touch panel described above; and

a liquid crystal display module.

Differences from other embodiments are highlighted in each embodiment of the specification, and the same or similar parts of the embodiments can be referred to each other.

The embodiments of the invention may be practiced or applied by those skilled in the art based on the above illustration for the disclosed embodiments. Various modifications to the embodiments are apparent for the skilled in the art. The general principle suggested herein can be implemented in other embodiments without departing from the spirit or scope of the disclosure.

Therefore, the present invention should not be limited to the embodiments disclosed herein, but has the widest scope that is in conformity with the principle and the novel features disclosed herein.

1. A self-capacitive touch panel comprising:
a plurality of self-capacitive touch sensing electrodes arranged on a single layer;
a touch control circuit configured to drive the plurality of self-capacitive touch sensing electrodes, to detect the changes of the self-capacitances of the plurality of self-capacitive touch sensing electrodes, and to determine a touch position based on the changes of the self-capacitances;
an insulating layer covering the surface of each of the plurality of self-capacitive touch sensing electrodes; and
an isolating electrode covering the surface of the insulating layer and connected to the touch control circuit.

2. The self-capacitive touch panel according to claim 1, wherein the touch control circuit is configured to drive the isolating electrode with a fixed electrical level.

3. The self-capacitive touch panel according to claim 1, wherein the touch control circuit is configured to drive the isolating electrode with a driving signal for driving the plurality of self-capacitive touch sensing electrodes.

4. The self-capacitive touch panel according to claim 1, wherein the self-capacitive touch sensing electrodes are in a shape of triangle.

5. The self-capacitive touch panel according to claim 1, wherein the isolating electrode is made of Indium Tin Oxide or Graphene.

6. A touch display device comprising:
a self-capacitive touch panel, the touch panel comprising:
a plurality of self-capacitive touch sensing electrodes arranged on a single layer;
a touch control circuit configured to drive the plurality of self-capacitive touch sensing electrodes, to detect the changes of the self-capacitances of the plurality of self-capacitive touch sensing electrodes, and to determine a touch position based on the changes of the self-capacitances;
an insulating layer covering the surface of each of the plurality of self-capacitive touch sensing electrodes; and
an isolating electrode covering the surface of the insulating layer and connected to the touch control circuit; and
a liquid crystal display module.
